(19) United States
(12) Patent Application Publication
(10) Pub. No.: US 2007/0005602 A1
(43) Pub. Date: Jan. 4, 2007

(54) Method, electronic device and computer program product for identifying entities based upon innate knowledge

(75) Inventor: Stefano Campadello, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/170,376

(22) Filed: Jun. 29, 2005

(51) Int. Cl. G06F 17/30

(52) U.S. Cl. 707/10

(57) ABSTRACT

Methods, electronic devices and computer program products are provided for identifying other entities in a trustworthy manner, such as in a decentralized network architecture. Each entity may include identification data associated other respective entities. As such, a series of messages that include queries and answers based upon the identification data can be passed between a pair of entities prior to commencing substantive communication in order to authenticate the entities. Additionally, entities that already have established a trusted relationship may introduce other entities to one another to permit each entity to communicate with a broader network of trusted entities.

### FIELD OF THE INVENTION

The present invention relates generally to electronic devices, methods and computer program products for facilitating communications with various entities across a network and, more particularly, to electronic devices, methods and computer program products for identification and verification of entities in a network.

### BACKGROUND OF THE INVENTION

Entities in a decentralized network communicate directly with each other without the use of a centralized server, authority, or database. For example, mobile terminals may communicate directly with each other using Bluetooth® technology, or entities using a peer-to-peer network may communicate directly with each other for purposes such as eCommerce, gaming, or file transfer. In any such network a significant factor in one entity's willingness to communicate with another is identification trustworthiness. Identification trustworthiness is the trust that one entity has that another's identification is authentic. However, in decentralized networks identification and verification of an entity is limited to the past and present knowledge of the entity by other entities in the network. In that regard, identification trustworthiness presents a significant problem in decentralized networks because no centralized authority, server, or database exists by which an entity's identity may be verified.

Although identity trustworthiness is a well-known problem, solutions have been largely limited to the centralized and hybrid network context. In centralized (client-server) networks an entity's identity is verified by a central server that regulates communication between the entities. Before entering the network the entity must first prove its identification to the central server by providing some form of information, such as a username and password, a pin number, or a code generated by a mathematical algorithm. Then, the central server compares the information provided by the entity to information drawn from a central database. If the information provided by the entity is correct, the central server will verify for others that the entity's identification is authentic and will allow the entity to communicate on the network. Other systems may use a hybrid network architecture, utilizing a centralized structure for some functions, such as searching for entities on the network, but a decentralized structure for other functions, such as communication between entities. In such systems, the central server may be used to verify the identification of the entities.

One example of the problem of identification trustworthiness in centralized and hybrid networks is evident in the eCommerce context. In eCommerce peer-to-peer communities are often dynamically established by entities that are unrelated or unknown to each other. Consequently, entities are vulnerable to risks of potential transaction fraud. By establishing trustworthiness, entities are able to provide others with a greater expectation of satisfaction in a transaction.

Typically in eCommerce entity trustworthiness is established using a basic reputation based feedback method. In such a system, entities rate the trustworthiness of another entity based on their satisfaction in past transactions with that entity. The feedback can be positive, negative, or neutral. After a number of positive transactions, an entity will build upon a positive trustworthiness rating and others will be more willing to transact with the entity. Examples of Internet sites which utilize this feedback method include, eBay, Yahoo!Auction, and ActionUniverse. However, basic reputation-based feedback systems are susceptible to biased and dishonest feedback or situations where an entity conspires with others or creates pseudo identities to artificially boost its feedback ratings.

A reputation-based trust model for peer-to-peer eCommerce communication, which attempts to correct problems with biased or fraudulent feedback is disclosed by Li Xiong, et al., A Reputation-Based Trust Model for Peer-to-Peer eCommerce Communities, Proceedings of the International Conference on E-Commerce (2003). The model includes two main features. The first feature of the model uses three basic trust parameters: a parameter for feedback in terms of the amount of satisfaction, based on past transactions, that an entity obtains from other entities, a parameter for the total number of transactions an entity performs, and a parameter, based on past behavior of entities who file feedback, for the credibility of the feedback source. The second feature of the model uses two adaptive trust factors: a transaction context factor, based on the typical types of transactions an entity executes, and a community context factor, based on the type of peer-to-peer community with which an entity typically transacts. Ideally, the trust parameters and adaptive trust factors will lower the probability of instances of fraud and biased feedback.

Nevertheless, reputation-based feedback methods generally require a central server and database to validate an entity's identity and to store its respective reputation-based feedback rating. If a central server and database were not used, then each entity would be responsible for maintaining its own rating, and, conceivably, an entity could access and artificially manipulate its rating.

Other methods for verifying an entity's identification include usernames and passwords, pin numbers, and codes generated by a mathematical algorithm. However, these methods are static in nature and, as a result, are susceptible to being stolen, guessed, decoded, or reverse engineered. Additionally, these methods may require a central server and database by which the usernames and passwords, pin numbers, and codes may be verified.

Another method for verifying an entity's identification uses codes which periodically change. The entity must both possess a means for temporarily generating a code which may be verified by another who is also capable of contemporaneously generating an identical code. This method is used in some client/server networks, but it is logistically difficult and costly to implement. In a decentralized network, the practical application of synchronizing any entity to another presents significant logistical challenges. In addition, a means for periodic code generation may be susceptible to being stolen, decoded, or reverse engineered.

Another method for verifying an entity's identification may use any of the above methods previously discussed coupled with the use of questions and answers. In typical use, an entity enters a network using any general means of identification. Once in the network, if the entity enters into circumstances of heightened security, the entity is required to provide answers to any number of questions. The answers that the entity now provides are compared with answers to these same questions that were previously, typically during registration of the entity, and stored in a central database. If the original answers match the answers provided by the entity in a later circumstance, then the entity is allowed to continue. But, this method also requires a central authority and database to verify the entity.

Therefore, the conventional authentication techniques do not adequately address issues related to identification trustworthiness in decentralized networks that lack a central authority and/or a central database. With the growing utilization of decentralized networks, however, there is an increasing desire to provide techniques for facilitating identification trustworthiness between entities communicating via a decentralized network.

### SUMMARY OF THE INVENTION

In light of the foregoing background, embodiments of the present invention provide an improved method, electronic device, and computer program product for providing identification trustworthiness in decentralized networks and, more generally, in any network that is desirous of additional identification trustworthiness. In that regard, embodiments of the present invention use identification data of an entity that is known by one or more other entities to verify the identification trustworthiness of the entity. Accordingly, when a first entity communicates across a network with other entities, the other entities can verify the identification trustworthiness of the first entity by comparing identification data provided by the first entity with identification data, typically stored by the other entities in one or more databases, associated with the first entity and accessible to the other entities. Conversely, the first entity can verify the identification trustworthiness of the other entities on the network by comparing identification data, provided by the other entities, with identification data, typically stored by the other entities in one or more databases, respectively associated with the other entities and accessible to the first entity. Furthermore, trusted entities may introduce new entities to one another by exchanging identification data associated with the new entities.

Accordingly, the method, electronic device, and computer program product of embodiments of the present invention are capable of receiving from a first entity an initial message comprising a query to a second entity. This initial message may include either a descriptor identifying the first entity or identification data associated with the first entity or both. In this regard, the identification data may be in the form of an n-tuple. The method, electronic device, and computer program product may then be capable of responding to the initial message with a response message comprising identification data and a query to the first entity, wherein the data may be obtained by the second entity from a database that includes data associated with the second entity and wherein the query to the first entity is based on data that may be obtained by the second entity from a database that includes data associated with the first entity. Next, the method, electronic device, and computer program product may be capable of receiving from the first entity a reply message to the response message, wherein the reply message comprises identification data associated with the first entity. Further, the data received from and associated with the first entity may be validated by comparing the data with data obtained by the second entity from the database that includes data associated with the first entity, thereby permitting the identity of the first entity to be authenticated. Advantageously, the authentication can take place over a decentralized network, wherein the method, electronic device, and computer program product can be capable of controlling access to the database associated with the second entity.

In addition to being able to validate the authentication of an entity, even over a decentralized network, the method, electronic device, and computer program product of embodiments of the present invention can be capable of receiving from a first entity a request message comprising a descriptor of at least one third entity and responding to the first entity with a response message with data obtained by the second entity from a database that includes data associated with the third entity. In this embodiment, the method, electronic device, and computer program product can be capable of introducing one or more new entities, e.g., the third entity, to the first entity.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as an electronic device such as a terminal or a computing system, in accordance with embodiments of the present invention;

FIG. 3 is a schematic block diagram of a mobile station, in accordance with one embodiment of the present invention; and

FIG. 4 is a schematic representation of entity to entity communication, in accordance with at least one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

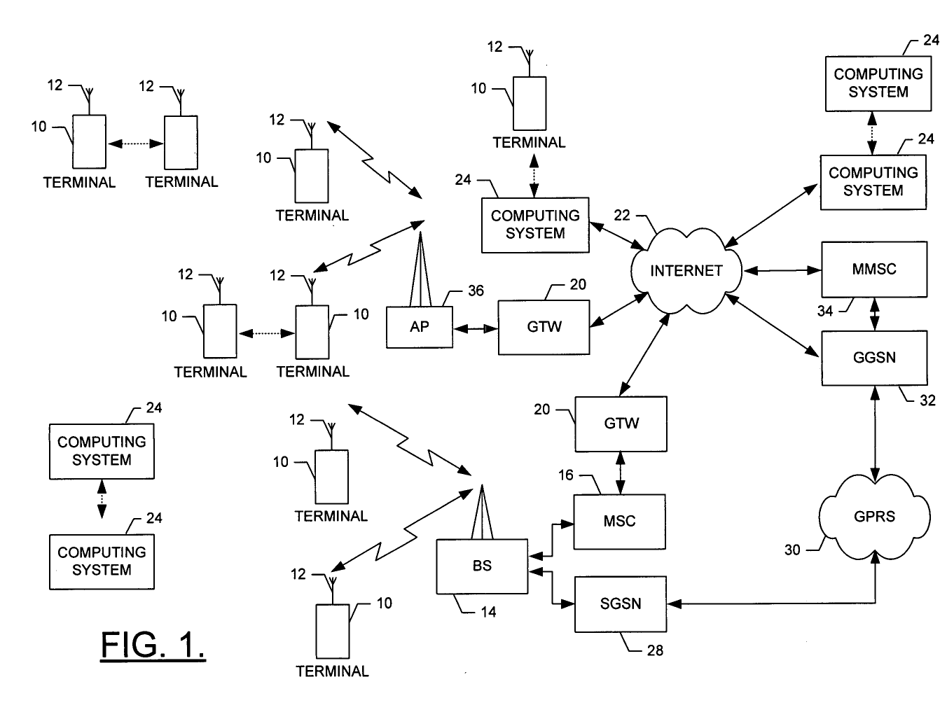

Referring to FIG. 1, an illustration of one type of terminal and system that would benefit from embodiments of the present invention is provided. The method, electronic device, and computer program product of embodiments of the present invention will be primarily described in conjunction with mobile communications applications. It should be understood, however, that the method, electronic device, and computer program product of embodiments of the present invention can be utilized in conjunction with a variety of other applications, both in the mobile communications industries and outside of the mobile communications industries. For example, the method, electronic device, and computer program product of embodiments of the present invention can be utilized in conjunction with wireline and/or wireless network applications.

As shown, one or more terminals 10 may each include an antenna 12 for transmitting signals to and for receiving signals from a base site or base station (BS) 14. The base station is a part of one or more cellular or mobile networks that each include elements required to operate the network, such as a mobile switching center (MSC) 16. As well known to those skilled in the art, the mobile network may also be referred to as a Base Station/MSC/Interworking function (BMI). In operation, the MSC is capable of routing calls to and from the terminal when the terminal is making and receiving calls. The MSC can also provide a connection to landline trunks when the terminal is involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the terminal 10 via the Internet. For example, as explained below, the processing elements can include one or more processing elements associated with a computing system 24 or the like.

The BS 14 can also be coupled to a signaling GPRS (General Packet Radio Service) support node (SGSN) 28. As known to those skilled in the art, the SGSN is typically capable of performing functions similar to the MSC 16 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 30. The packet-switched core network is then coupled to another GTW, such as a GTW GPRS support node (GGSN) 32, and the GGSN is coupled to the Internet. In addition to the GGSN, the packet-switched core network can also be coupled to a GTW 20. Also, the GGSN can be coupled to a messaging center, such as a multimedia messaging service (MMS) center 34. In this regard, the GGSN and the SGSN, like the MSC, can be capable of controlling the forwarding of messages, such as MMS messages. The GGSN and SGSN can also be capable of controlling the forwarding of messages for the terminal to and from the messaging center.

In addition, by coupling the SGSN 28 to the GPRS core network 30 and the GGSN 32, devices such as a computing system 24 can be coupled to the terminal 10 via the Internet 22, SGSN and GGSN. In this regard, devices such as a computing system can communicate with the terminal across the SGSN, GPRS and GGSN. By directly or indirectly connecting the terminals and the other devices (e.g., computing system, etc.) to the Internet, the terminals can communicate with the other devices and with one another, such as according to the Hypertext Transfer Protocol (HTTP), to thereby carry out various functions of the terminal.

Although not every element of every possible mobile network is shown and described herein, it should be appreciated that the terminal 10 can be coupled to one or more of any of a number of different networks through the BS 14. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The terminal 10 can further be coupled to one or more wireless access points (APs) 36. The APs can comprise access points configured to communicate with the terminal in accordance with techniques such as, for example, radio frequency (RF), Bluetooth (BT), infrared (IrDA) or any of a number of different wireless networking techniques, including WLAN techniques. The APs 36 may be coupled to the Internet 22. Like with the MSC 16, the APs can be directly coupled to the Internet. In one embodiment, however, the APs are indirectly coupled to the Internet via a GTW 20. As will be appreciated, by directly or indirectly connecting the terminals and the computing system 24, and/or any of a number of other devices, to the Internet, the terminals can communicate with one another, the computing system, etc., to thereby carry out various functions of the terminal, such as to transmit data, content or the like to, and/or receive content, data or the like from, the computing system. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

In addition to or in lieu of coupling the terminal 10 to computing systems 24 across the Internet 22, the terminal and computing system can be coupled to one another and communicate in accordance with, for example, RF, BT, IrDA or any of a number of different wireline or wireless communication techniques, including LAN and/or WLAN techniques. Further, the terminal 10 and computing system 24 can be coupled to one or more electronic devices, such as printers, digital projectors and/or other multimedia capturing, producing and/or storing devices (e.g., other terminals). Like with the computing systems, the terminal can be configured to communicate with the portable electronic devices in accordance with techniques such as, for example, RF, BT, IrDA or any of a number of different wireline or wireless communication techniques, including USB, LAN and/or WLAN techniques.

Furthermore, two or more terminals 10 can be coupled to one another and communicate in accordance with, for example, RF, BT, IrDA or any of a number of different wireline or wireless communication techniques, including LAN and/or WLAN techniques. In addition, two or more computing systems 24 can be coupled to one another and communicate in accordance with, for example, RF, BT, IrDA or any of a number of different wireline or wireless communication techniques, including LAN and/or WLAN techniques, or in accordance with removable memeory.

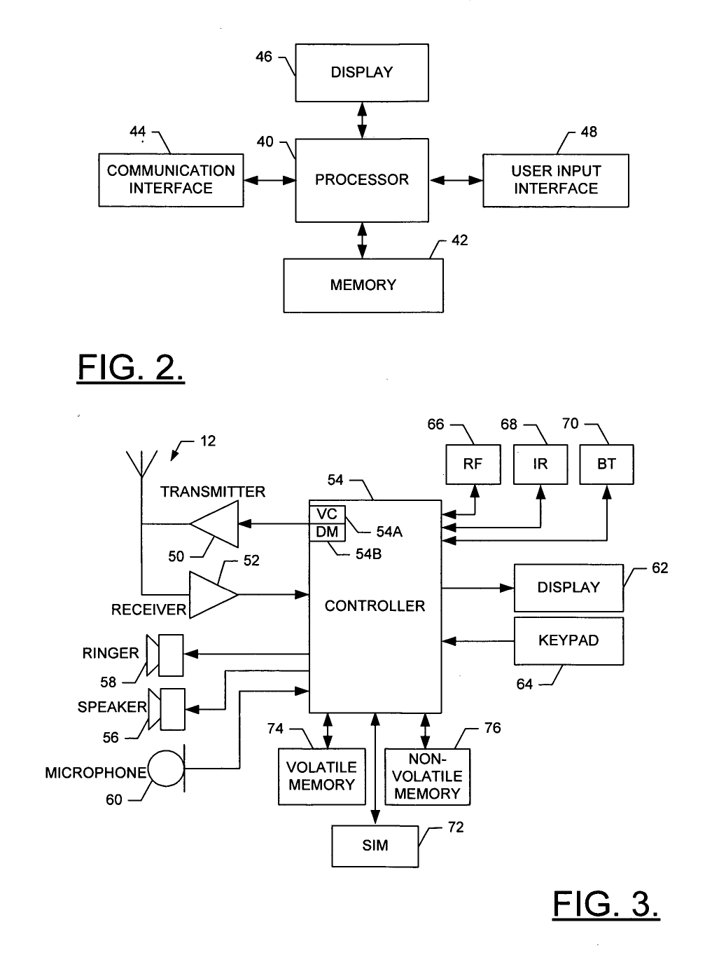

Referring now to FIG. 2, a block diagram of an entity capable of operating as a terminal 10 and/or computing system 24 is shown in accordance with one embodiment of the present invention. The entity capable of operating as a terminal, and/or computing system includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a terminal 10 and/or computing system 24 can generally include a processor 40 connected to a memory 42. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

Reference is now made to FIG. 3, which illustrates one type of terminal 10 that would benefit from embodiments of the present invention. It should be understood, however, that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as portable digital assistants (PDAs), pagers, laptop computers and other types of electronic systems, can readily employ embodiments of the present invention.

The terminal 10 includes various means for performing one or more functions in accordance with exemplary embodiments of the present invention, including those more particularly shown and described herein. It should be understood, however, that the terminal may include alternative means for performing one or more like functions, without departing from the spirit and scope of the present invention. More particularly, for example, as shown in FIG. 3, in addition to an antenna 12, the terminal 10 includes a transmitter 50, a receiver 52, and a controller 54 that provides signals to and receives signals from the transmitter and receiver, respectively. These signals include signaling information in accordance with the air interface standard of the applicable cellular system, and also user speech and/or user generated data. In this regard, the terminal can be capable of operating with one or more air interface standards, communication protocols, modulation types, and access types. More particularly, the terminal can be capable of operating in accordance with any of a number of first generation (1G), second generation (2G), 2.5G and/or third-generation (3G) communication protocols or the like. For example, the terminal may be capable of operating in accordance with 2G wireless communication protocols IS-136 (TDMA), GSM, and IS-95 (CDMA). Also, for example, the terminal may be capable of operating in accordance with 2.5G wireless communication protocols GPRS, Enhanced Data GSM Environment (EDGE), or the like. Further, for example, the terminal may be capable of operating in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 54 includes the circuitry required for implementing the audio and logic functions of the terminal 10. For example, the controller may be comprised of a digital signal processor device, a microprocessor device, and various analog-to-digital converters, digital-to-analog converters, and other support circuits. The control and signal processing functions of the terminal are allocated between these devices according to their respective capabilities. The controller can additionally include an internal voice coder (VC) 54A, and may include an internal data modem (DM) 54B. Further, the controller may include the functionality to operate one or more software programs, which may be stored in memory (described below). For example, the controller may be capable of operating a connectivity program, such as a conventional Web browser. The connectivity program may then allow the terminal to transmit and receive Web content, such as according to HTTP and/or the Wireless Application Protocol (WAP), for example.

The terminal 10 also comprises a user interface including a conventional earphone or speaker 56, a ringer 58, a microphone 60, a display 62, and a user input interface, all of which are coupled to the controller 54. The user input interface, which allows the terminal to receive data, can comprise any of a number of devices allowing the terminal to receive data, such as a keypad 64, a touch display (not shown) or other input device. In embodiments including a keypad, the keypad includes the conventional numeric (0-9) and related keys (#, *), and other keys used for operating the terminal. Although not shown, the terminal can include a battery, such as a vibrating battery pack, for powering the various circuits that are required to operate the terminal, as well as optionally providing mechanical vibration as a detectable output.

The terminal 10 can also include one or more means for sharing and/or obtaining data. For example, the terminal can include a short-range radio frequency (RF) transceiver or interrogator 66 so that data can be shared with and/or obtained from electronic devices in accordance with RF techniques. The terminal can additionally, or alternatively, include other short-range transceivers, such as, for example an infrared (IR) transceiver 68, and/or a Bluetooth (BT) transceiver 70 operating using Bluetooth brand wireless technology developed by the Bluetooth Special Interest Group. The terminal can therefore additionally or alternatively be capable of transmitting data to and/or receiving data from electronic devices in accordance with such techniques. Although not shown, the terminal can additionally or alternatively be capable of transmitting and/or receiving data from electronic devices according to a number of different wireless networking techniques, including WLAN techniques such as IEEE 802.11 techniques or the like.

The terminal 10 can further include memory, such as a subscriber identity module (SIM) 72, a removable user identity module (R-UIM) or the like, which typically stores information elements related to a mobile subscriber. In addition to the SIM, the terminal can include other removable and/or fixed memory. In this regard, the terminal can include volatile memory 74, such as volatile Random Access Memory (RAM) including a cache area for the temporary storage of data. The terminal can also include other non-volatile memory 76, which can be embedded and/or may be removable. The non-volatile memory can additionally or alternatively comprise an EEPROM, flash memory or the like. The memories can store any of a number of pieces of information, and data, used by the terminal to implement the functions of the terminal. For example, the memories can store an identifier, such as an international mobile equipment identification (IMEI) code, international mobile subscriber identification (IMSI) code, mobile station integrated services digital network (MSISDN) code (mobile telephone number), Session Initiation Protocol (SIP) address or the like, capable of uniquely identifying the mobile station, such as to the MSC 16. As explained below, the memories can also store one or more applications capable of operating on the terminal.

As explained in the background section, in various instances one entity, such as a terminal 10 or computing system 24, may desire to authenticate the identification trustworthiness of another entity. For example, an entity may desire to authenticate one or more other entities prior to substantively communicating via a decentralized network such as a peer-to-peer network; be it for eCommerce or gaming applications or otherwise. Therefore, embodiments of the present invention provide a method, electronic device, and computer program product for addressing the issue of identification trustworthiness.

In accordance with embodiments of the present invention, two or more entities may desire to communicate but only once the identity of the other entity has been authenticated. As described above in conjunction with FIG. 1, the entities may be capable of operating in various networks including a fixed network environment (e.g., LAN, MAN, WAN, etc.) and/or a cellular network environment (e.g., TDMA, GSM, CDMA, GPRS, EDGE, MBMS, DVB, CSD, HSCSD, etc.) as well as directly via any of a variety of direct communication techniques (eg RF, BT, IrDA or any of a number of different wireline or wireless communication techniques). In order to authenticate one another, the entities may exchange identification data as well as identity descriptors.

In that regard, identity descriptors can identify one or more particular entities by a designation that is unique to the respective entity or to a group of entities to which the respective entity belongs. As such, an identity descriptor may be a name, serial number, internet protocol address, an Internet or wide area network (WAN) e-mail address, a corporate or local area network (LAN) e-mail address, a mobile e-mail address, a landline telephone number, a mobile telephone number, or any other general pseudonym or other identifier, including an identification based on secondary (intrinsic) information.

In addition, identification data may describe one or more particular entities. Identification data is general data, which is associated with a particular entity or group of entities and which may be used to identify the entity or group of entities. In one embodiment, for example, identification data comprises a finite list of data wherein each data element in the data list is an n-tuple having n terms with n being an integer that is greater than or equal to 2. For example, each data element in a data list may be a pair of numbers (d1, d2), a set of three numbers (d1, d2, d3), a set of four numbers (d1, d2, d3, d4) or the like. Furthermore, in this embodiment, the data list that is associated with the entity or group of entities contains data particularized to the entity or group of entities, and, although two or more distinct entities may share similar data elements, the probability of two distinct entities or two distinct entity groups having identical data lists decreases as the list size increases. Therefore, an entity or group of entities may be identified by the data list that is particularized to the entity or group of entities. While identification data is described herein as elements of a data list comprising n-tuples, identification data may, instead, be designed as one of many data structures, including, for example, arrays, lists, trees, maps, tables, or, more generally, any type of abstract data structure, and may be represented as one of many different representations.

For purposes of the present invention, the conceptual and/or physical location where identification data associated with a particular entity or group of entities is stored is unimportant to the functionality of the invention, provided that the identification data is accessible to the entity or group of entities. However, embodiments of the present invention are advantageous in that the identification trustworthiness of an entity is maintained even when the entity maintains its identification data locally because, unlike the common reputation based models, few, if any, incentives exist for the entity to artificially manipulate the identification data associated with itself. For example, in one embodiment, the identification data associated with an entity may be locally stored by the entity in a database located in the memory 42 of the entity.

As described below and in accordance with one embodiment of the present invention, when a first entity communicates with one or more other entities, the other entities can verify the identification trustworthiness of the first entity by comparing identification data, sent to other entities from the first entity, with data from one or more databases associated with the first entity and accessible to the other entities. Conversely, the first entity can verify the identification trustworthiness of the other entities by comparing identification data, sent to the first entity from the other entities, with data from one or more databases respectively associated with the other entities and accessible to the first entity. Furthermore, a first entity that is trusted by another entity may introduce a new entity to the other entity by sending identification data, associated with the new entity, to the other entity.

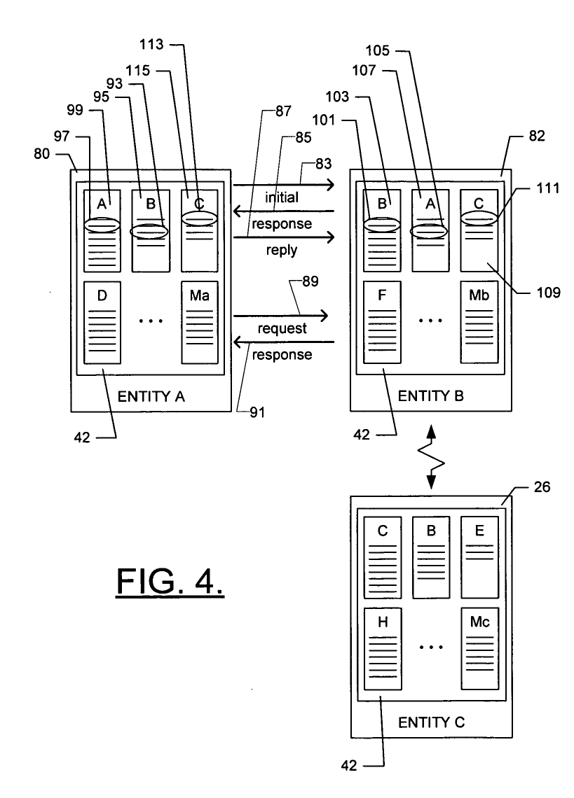

Reference is now drawn to FIG. 4, which illustrates a functional block diagram of an entity A 80 that desires to communicate with an entity B 82. As shown, communication is initiated between entities A and B when entity A sends an initial message 83 comprising a query to entity B. The query to entity B is based on data that is obtained by entity A from a database 95 that includes data associated with entity B. Additionally, the initial message may contain additional identification data and/or an identity descriptor associated with entity A.

In one embodiment, for example, the initial message 83 comprises a query to entity B 82, which is based on the first term of a data element 93 selected, typically randomly, from a data list in a database 95 associated with entity B 82 and stored in memory 42 of entity A 80. For example, if one data element from the data list associated with entity B is (d1, d2), the query from entity A to entity B may simply provide d1 which should prompt entity B to return d2 during the authentication process. Further, the initial message may comprise identification data which is based on a data element 97 of a data list in a database 99 associated with entity A and contained in memory of entity A. For example, if the data list associated with entity A includes (d3, d4), the initial message to entity B may also include (d3, d4).

Next in this embodiment, entity B 82 responds to the initial message 83 with a response message 85 comprising an answer to the query posed by entity A, identification data and a query to entity A 80. With respect to the answer to the query posed by entity A, entity B reviews the data list associated with itself and identifies the data element 101 that includes the term, e.g., d1, provided by entity A with the answer being the other term of that same data element, e.g., d2. As to the identification data, entity B provides a data element, e.g., (d5, d6), from a database 103 that includes data associated with the entity B. Finally, the query to entity A is based on data that is obtained by entity B from a database 107 that includes data associated with entity A. As described above, the query may be one term of a data element 105 from the data list associated with entity A, but accessible by entity B. For example, if one data element from the data list associated with entity A is (d7, d8), the query from entity B to entity A may simply provide d7 which should prompt entity A to return d8. It is noted that, in this embodiment, entity B identified entity A and located the data list associated with entity A based upon the identification data provided by entity A. In addition or in the alternative, entity A could have provided an identifier as described below in conjunction with the initial message. Likewise, the response by entity B to the initial message may contain an identifier associated with entity B.

By way of example, entity A may initially send Message1 consisting of (3;(12,7645)) to entity B wherein 3 is a query to entity B and (12,7645) is a data element from the data list associated with entity A. Entity B can then answer with Message2 consisting of ((3,78);(1,987);(12,7645);6) wherein 78 is the answer to the query to B, (1,987) is a data element from the data list associated with entity B, (12,7645) is the repetition of the data element from the data list associated with entity A and 6 is a query to entity A.Entity A can then answer with Message3 consisting of ((12,7645);(6,2323);(3,78);(1,987)) to entity B wherein 2323 is the answer to the query and the other couples represent the repetition of data elements that have been previously exchanged. Assuming that the answers to the queries match with the expected answers, entities A and B can be considered sufficiently authenticated so as to support subsequent communicate.

As described above, the identification data may be sent from a first entity to a second entity as a show of good faith. In instances in which the identification data is already included in the data list maintained by the second entity and associated with the first entity, the identification data can be utilized to assist in the identification of the first entity. Or, in instances in which the identification data is not already contained in the data list maintained by the second entity and associated with the first entity, the identification data can be added to the data list to make the data list more complete. While the transmission of the identification data may be useful, the identification data transmitted by entity B in the above-described embodiment is optional since entity A is already authenticating entity B based on its response to the query. Additionally, in instances in which the initial message from entity A includes an identifier, the identification data is likewise an optional part of the initial message since the identification data is no longer required for authentication purposes.

Based upon the response by entity B, entity A may reply in comparable fashion to that described above with respect to entity B by answering the query, optionally providing additional identification data and posing another query of entity B. This process may then continue as many times as desired with the confidence that the entities are actually A and B increasing with each successful exchange. At some point in time, such as after passing a predefined number of messages or exhausting the queries that could be posed to the other entity, the entities will be considered properly authenticated and substantive communication may commence. In this regard, identification trustworthiness is generally considered to be established between entitites A and B if both entity A and entity B are sufficiently satisfied with the probability that the other entity's identification is authentic. Alternatively, if the answers to any one or any other predefined number of the queries prove incorrect during this exchange of messages, the authentication process may be terminated with the entity that provided the incorrect answer failing to be authenticated.

In another embodiment, entity A may send an initial message 83 that not only includes a query to entity B, but also an identity descriptor of A, either instead of or in addition to the identification data associated with entity A to entity B 82. In instances in which entity A provides both an identity descriptor and identification data, entity B may validate the authenticity of the identification data by comparing it with a data element 105 of a data list associated with entity A, as identified by the identity descriptor, in a database 107 contained in memory 42 of entity B. If the identification data is not included in the data list associated with entity A, the probability that entity A's identity is authentic does not change, but entity B may supplement the database associated with entity A in entity B's memory by adding the identification data received from entity A to the data list. Consequentially, over time the data list associated with entity A in a database contained in memory of entity B may increase in size as entity B and entity A continue to communicate.

In this embodiment, the identity descriptor sent by entity A in the initial message is a declaration of entity A's identity. As such, entity B can use the identity descriptor to reference the particular data list associated with entity A. However, it is not necessary that entity A sends an identity descriptor, as, for example, entity B could otherwise search through all data lists of the entities known to entity B to find those data lists which contain the identification data sent from entity A in the initial message. From this pool of data lists, the number of data lists that could potentially be associated with entity A could be narrowed down by entity B as additional identification data is exchanged between entities A and B until conceivably only the data list associated with entity A remained, thus identifying entity A as the sender. Still further, in instances in which entity A provides an identity descriptor, the identification data need not necessarily be provided, although the identification data is useful for providing further authentication is desired.

Regardless of whether entity A has provided identification data, entity B 82 sends the response message 85 to entity A 80 with an answer to the query posed by entity A, a query directed to entity A and one or both of an identity descriptor of entity B and identification data associated with entity B. Entity A then evaluates the response message as described above and one or more additional messages may be exchanged to further increase the trustworthiness of the identification of the entities, if so desired. See, for example, the reply 87 sent from entity A to entity B which may include, at a minimum, an answer to the query posed by entity B.

As described above, embodiments of the present invention permit entities to authenticate one another in a decentralized network in instances in which each entity possess some information, e.g., a data list, in advance regarding the other entity. In some situations, however, it would be desirable to authenticate and communicate with an entity with whom there is no preexisting information. In this situation, embodiments of the present invention permit one entity to query the other entity that it trusts in an attempt to obtain information, such as identification data from which a data list could be constructed, that will permit the new entity to be authenticated.

In this regard, once identification trustworthiness between entity A 80 and entity B 82 is established, either entity may introduce a new entity to the other. In this way, either entity A or entity B may vouch for the authenticity of the identity of the new entity. Although the other entity may not know anything about the new entity, the other entity may accept the identity of the new entity as authentic based upon the representation from the trusted entity. For example, as shown in FIG. 4, if entity A and entity B have established identification trustworthiness and if entity B and entity C 26 have also established identification trustworthiness, then entity B may vouch for the identification trustworthiness of entity C to entity A. In accordance with the example in which entity A has received a request message from entity C or in which entity A otherwise wants to establish communications with entity C, entity A may send to entity B (as well as optionally other entities trusted by entity A) a request message 89 comprising a request to entity B for identification data associated with entity C, since entity A does not otherwise know or trust entity C. Entity A may identify entity C to entity B by providing, in the request message to entity B, an identity descriptor of entity C or other identification data associated with entity C, either or both of which may have been provided by entity C. Next, entity B responds to entity A (once entity B has authenticated entity A by the process described above) by sending to entity A a response message 91 comprising identification data 111 associated with entity C and obtained by entity B from a database 109 that includes data associated with entity C. For purposes of the present invention, the conceptual and/or physical location of the database from which entity B obtains data associated with entity C is unimportant to the functionality of the invention, provided that the data obtained is substantially trustworthy to entity B. Subsequently, entity A may supplement a database 115 associated with entity C by adding the identification data 113 received from entity B to it. Entity A and entity B may continue to repeat this process if entity B does not provide all of the identification data associated with entity C in the initial response and over time the database accessible to entity A and associated with entity C may increase is size. In that regard, entity A will have identification data associated with entity C even though entity A has never directly communicated with entity C. Instead of providing the identification data associated with entity C in a piecemeal fashion, entity B in the foregoing example may provide all of the identification data that entity B has maintained for entity C in the initial response.

By way of a simple example in which entities A and B have been previously authenticated, entity A may ask entity B to introduce entity A to entity C. In this regard, entity A may send Message4 consisting of ((C;(6,2323)) to entity B wherein C is an identity descriptor or other identification data of entity C and (6,2323) is a data element from the data list associated with entity A. Entity B may then answer with Message5 consisting of ((8,765);(3,78) to entity A wherein (8,765) is a data element from a data list associated with entity C and known by entity B and (3,78) is a data element from a data list associated with entity B. As such, entity A can collect information regarding entity C before ever meeting entity C.

Additionally, two entities that have authenticated one another and, therefore, trust one another, may seek to verify the identity of a third entity. In this regard, the two trusted entities may each include identification data associated with the third entity and the two trusted entities may communicate with one another so as to compare the identification data maintained by each of the trusted entities and relating to the third entity. If the identification data maintained by each of the trusted entities relating to the third entity matches or, at least, is not inconsistent, the identity of the third entity may be considered to be verified. Alternatively, if the identification data maintained by each of the trusted entities relating to the third entity is inconsistent, the third entity may not be trusted. For example, if the identification data relating to the third entity that is maintained by one of the trusted entities includes (d1, d2) and the identification data relating to the third entity that is maintained by the other of the trusted entities includes (d1, d7), the trusted entities may determine that the identity of the third entity is untrustworthy since d1 is improperly paired with different values in the identification data maintained by each of the trusted entities and relating to the third entity.

According to one aspect of the present invention, the functions performed by one or more of the entities of the system may be performed by various means, such as hardware and/or firmware, including those described above, alone and/or under control of a computer program product. The computer program product for performing the methods of embodiments of the present invention includes a computer-readable storage medium, such as memory 42, and computer-readable program code portions, such as a series of computer instructions, embodied in the computer-readable storage medium.

In this regard, FIG. 4 is an example of a flow diagram of one embodiment of the methods and computer program products according to the present invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart's block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart's block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowcharts' block(s) or step(s).

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Referring to FIG. 3, in another embodiment, for example, all or a portion of the methods of the present invention, such as all or a portion of the operations of the entities and/or all or a portion of the communication between the entities, generally operates under the control of one or more electronic devices, such as one ore more terminals or the like. In such an embodiment, the volatile memory 74 and/or non-volatile memory 76 contain a computer program product for performing one or more of the methods of embodiments of the present invention. Additionally, the volatile memory 74 and/or non-volatile memory 76 may contain one or more databases in which the identity descriptors and/or identification data or one or more entities may be stored.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of authenticating a first entity and a second entity, the method comprising:
receiving an initial message from the first entity, the initial message comprising a query to the second entity;
transmitting a response message to the first entity, the response message comprising data and a query to the first entity, wherein the data is predefined and is associated with the second entity and wherein the query to the first entity is based on data that is also predefined and associated with the first entity; and
receiving a reply message from the first entity, the reply message comprising data associated with the first entity.

2. A method according to claim 1, wherein receiving the initial message further comprises receiving a descriptor identifying the first entity.

3. A method according to claim 1, wherein receiving the initial message further comprises receiving data associated with the first entity.

4. A method according to claim 1 further comprising validating the data received from and associated with the first entity by comparing the data with data obtained by the second entity from a database that includes the predefined data associated with the first entity.

5. A method according to claim 1 further comprising controlling access to a database that includes the predefined data associated with the second entity.

6. A method according to claim 1 further comprising:
receiving a request message from the first entity, the request message comprising a descriptor of at least one third entity; and
transmitting a response message to the first entity, the response message comprising data obtained by the second entity from a database that includes predefined data associated with the third entity.

7. A method according to claim 6, wherein receiving the descriptor comprises receiving a descriptor identifying a plurality of third entities, and wherein transmitting the response message further comprises responding with data for each third entity for which the second entity has predefined data stored in an associated database.

8. A method according to claim 1, wherein each of said receiving and transmitting steps comprises receiving and transmitting messages, respectively, via at least one wireline connection or wireless connection.

9. A method according to claim 1 further comprising:
storing the predefined data associated with the first entity in a database accessible by the second entity; and
supplementing the database with additional data provided by the first entity.

10. A method according to claim 1, wherein each of said receiving and transmitting steps comprises receiving and sending data, respectively, in the form of at least one term of an n-tuple.

11. An electronic device for authenticating another device, the electronic device comprising:
a memory for storing predefined data associated with the electronic device and the other device; and
a processing element capable of receiving from the other device an initial message comprising a query to the electronic device, said processing element is also capable of transmitting a response message comprising predefined data and query to the other device, wherein the predefined data is obtained by the electronic device from said memory and wherein the query to the other device is based on predefined data that is also obtained by the electronic device from said memory, and wherein said processing element is also capable of receiving a reply message from the other device, wherein the reply message comprises data associated with the other device.

12. An electronic device according to claim 11, wherein said processing element is capable of receiving the initial message that further comprises a descriptor identifying the first entity.

13. An electronic device according to claim 11, wherein said processing element is capable of receiving the initial message that further comprises data associated with the other device.

14. An electronic device according to claim 11, wherein said memory further comprises at least one database containing the predefined data associated with the electronic device and the other device, and wherein said processing element is further capable of validating the data received from and associated with the other device by comparing the data with the predefined data obtained by the electronic device from the database that includes data associated with the other device.

15. An electronic device according to claim 14, wherein said processing element is further capable of controlling access to the database that includes data associated with the electronic device.

16. An electronic device according to claim 11, wherein said processing element is further capable of: (i) receiving a request message from the other device, the request message comprising a descriptor of at least one third entity and (ii) transmitting a response message to the other device, the response message comprising predefined data obtained by the electronic device from a database that includes data associated with the third entity.

17. An electronic device according to claim 16, wherein the processing element is further capable of receiving a descriptor identifying a plurality of third entities, and thereafter responding with data for each third entity for which the electronic device has data stored in an associated database.

18. An electronic device according to claim 11, further comprising a communication interface for receiving and responding via at least one wireline connection or wireless connection.

19. An electronic device according to claim 11, wherein said processing element is further capable of storing predefined data associated with the other device in the memory and supplementing the memory with additional data provided by the other device.

20. An electronic device according to claim 11, wherein said processing element is capable of sending and receiving data in the form of at least one term of an n-tuple.

21. A computer program product for authenticating a first entity and a second entity, the computer program product comprising at least one computer-readable storage medium having computer-readable program code portions stored therein, the computer-readable program code portions comprising:
a first executable portion capable of receiving an initial message from the first entity, the initial message comprising a query to the second entity;
a second executable portion capable of transmitting a response message to the first entity, the response message comprising data and a query to the first entity, wherein the data is predefined and is associated with the second entity and wherein the query to the first entity is based on data that is also predefined and associated with the first entity; and
a third executable portion capable of receiving a reply message from the first entity, the reply message comprising data associated with the first entity.

22. A computer program product according to claim 21, wherein the first executable portion is also capable of receiving the initial message that includes a descriptor identifying the first entity.

23. A computer program product according to claim 21, wherein the first executable portion is also capable of receiving the initial message that includes data associated with the first entity.

24. A computer program product according to claim 21 further comprising a fourth executable portion capable of validating the data received from and associated with the first entity by comparing the data with data obtained by the second entity from a database that includes the predefined data associated with the first entity.

25. A computer program product according to claim 21 further comprising a fourth executable portion capable of controlling access to a database that includes the predefined data associated with the second entity.

26. A computer program product according to claim 21 further comprising:
a fourth executable portion capable of receiving a request message from the first entity, the request message comprising a descriptor of at least one third entity; and
a fifth executable portion capable of transmitting a response message to the first entity, the response message comprising data obtained by the second entity from a database that includes data associated with the third entity.

27. A computer program product according to claim 26, wherein said fourth executable portion is also capable of receiving a descriptor identifying a plurality of third entities, and said fifth executable portion is also capable of transmitting data for each third entity for which the second entity has predefined data stored in an associated database.

28. A computer program product according to claim 21 further comprising:
a fourth executable portion capable of storing the predefined data associated with the first entity in a database accessible by the second entity; and
a fifth executable portion capable of supplementing the database with additional data provided by the first entity.

29. A computer program product according to claim 1, wherein each of the receiving and transmitting steps comprises receiving and sending data in the form of at least one term of an n-tuple.

30. A method of authenticating a first entity and a second entity, the method comprising:
receiving an initial query at the second entity from the first entity, the initial query comprising at least one term of an n-tuple associated with the second entity;
transmitting an n-tuple and a response query to the first entity in response to the query, the n-tuple comprising at least two terms associated with the second entity, and the response query comprising at least one term of an n-tuple associated with the first entity; and
receiving a reply at the second entity from the first entity, the reply comprising at least two terms of an n-tuple associated with the first entity.

31. A method according to claim 30, wherein receiving the initial query further comprises receiving a descriptor identifying the first entity.

32. A method according to claim 30, wherein receiving the initial query further comprises receiving at least two terms of an n-tuple associated with the first entity.

33. A method according to claim 30, further comprising validating the n-tuple associated with the first entity by comparing the n-tuple with an n-tuple obtained by the second entity from a database that includes n-tuples associated with the first entity.

34. A method according to claim 30 further comprising controlling access to a database that includes the n-tuples associated with the second entity.

35. A method according to claim 30 further comprising:
receiving a request query from the first entity, the request query comprising a descriptor of at least one third entity; and
transmitting at least two terms of an n-tuple associated with the third entity to the first entity.

36. A method according to claim 35, wherein receiving the descriptor comprises receiving a descriptor identifying a plurality of third entities and wherein transmitting at least two terms of an n-tuple associated with the third entities further comprises transmitting at least two terms of an n-tuple for each third entity for which the second entity has at least two terms of an associated n-tuple stored in an associated database.

37. A method according to claim 30, wherein each of said receiving and transmitting steps comprises receiving and sending n-tuples, respectively, via at least one wireline connection or wireless connection.

38. A method according to claim 30 further comprising:
storing n-tuples associated with the first entity in a database accessible by the second entity; and
supplementing the database with additional n-tuples provided by the first entity.

39. An electronic device for authenticating another device, the electronic device comprising:
a memory for storing predefined data associated with the electronic device and the other device; and
a processing element capable of receiving an initial query from the other device, the initial query comprising at least one term of an n-tuple associated with the electronic device, said processing element is also capable of transmitting an n-tuple and a response query in response to the query of the other device, the n-tuple comprising at least two terms associated with the electronic device, and the response query comprising at least one term of an n-tuple associated with the other device, and wherein said processing element is also capable of receiving a reply to the response query from the other device, the reply to the response query comprising at least two terms of an n-tuple associated with the other device.

40. An electronic device according to claim 39, wherein said processing element is capable of receiving the initial query that further comprises receiving a descriptor identifying the other device.

41. An electronic device according to claim 39, wherein said processing element is capable of receiving the initial query that further comprises receiving at least two terms of an n-tuple associated with the other device.

42. An electronic device according to claim 39, wherein said processing element is further capable of validating the n-tuple associated with the other device by comparing the n-tuple with an n-tuple obtained by the electronic device from a database that includes n-tuples associated with the other device.

43. An electronic device according to claim 39, wherein said processing element is further capable of controlling access to a database that includes n-tuples associated with the electronic device.

44. An electronic device according to claim 39, wherein said processing element is further capable of receiving a request query from the other device, the request query comprising a descriptor of at least one third entity, and wherein said processing element is further capable of transmitting at least two terms of an n-tuple associated with the third entity to the other device.

45. An electronic device according to claim 44, wherein said processing element is further capable of receiving a descriptor identifying a plurality of third entities, and thereafter transmitting at least two terms of an n-tuple for each third entity for which the electronic device has an at least two terms of an associated n-tuple stored in an associated database.

46. An electronic device according to claim 39, further comprising a communication interface for receiving and transmitting via at least one wireline connection or wireless connection.

47. An electronic device according to claim 39, wherein said processing element is further capable of storing n-tuples associated with the other device in a database and supplementing the database with additional n-tuples provided by the other device.
